(19) United States
(12) Patent Application Publication
(10) Pub. No.: US 2011/0014023 A1
(43) Pub. Date: Jan. 20, 2011

(54) Method and apparatus for transporting mail

(76) Inventors: Wolfgang Schwarz, Longboat Key, FL (US); Michael O. Norris, Colleyville, TX (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/800,813

(22) Filed: May 21, 2010

Related U.S. Application Data
(60) Provisional application No. 61/180,531, filed on May 22, 2009.

(51) Int. Cl. B62B 3/02; B62B 5/00; B60P 1/02

(52) U.S. Cl. 414/495; 414/812

(57) ABSTRACT

A method for transporting sorted mail includes steps sorting flat mail pieces from a sorting machine into a series of bins mounted on a rack; removing the series of bins from the rack toto shelves of an extraction cart; moving the loaded cart onto a delivery vehicle; removing the bins from the cart into positions for delivery; removing the mail from the bins and delivering the mail to the recipient.

A method for transporting sorted mail including sorting flat mail pieces from a sorting machine into a series of bins mounted on a rack; removing the series of bins from the rack toto shelves of an extraction cart; moving the loaded cart onto a delivery vehicle; removing the bins from the cart into positions for delivery; removing the mail from the bins and delivering the mail to the recipient.

This application claims priority of U.S. Provisional Application No. 61/180,531 filed May 22, 2009.

### FIELD OF THE INVENTION

The invention relates to mail transport carts for use in a postal sorting facility as currently operated by the U.S. Postal Service (USPS).

### BACKGROUND OF THE INVENTION

The USPS carries out mail sorting operations using automated sorting machines which include BIN AND CARTRIDGES TO WHICH MAIL IS SORTED, E.G. DBCS and MLOCR machines. These sorters include a feeder which feeds letters one at a time into a pinch belt conveyor system which transports each mail piece past a scanner or image lift camera that scans one or both faces of the mail piece for destination indicia, i.e. a printed bar code or address which can be read using optical character recognition (OCR). The mail is sorted automatically into pockets of a stacker, which are manually swept by postal workers, the contents being put into trays. The trays are then put onto carts for the next stage of postal processing. The cart currently used for this purpose, known as the 1226, is described further below.

Another commonly used cart in postal facilities for transport of mail in trays is the APC (all purpose container) comprises a pair of barred cages open at the front in which mail trays are stacked, often in an irregular manner. The bottom cage is mounted on wheels. It is approximately six feet high, two feet wide, and three and a half feet long. It weighs over 200 pounds empty and may carry over 800 pounds of mail. The APC has an upper and lower compartment. There is at least one reported case of an injury involving an APC, see, Ronald D. PRIOR, v. UNITED STATES POSTAL SERVICE, 985 F.2d 440. That accidents can happen is not surprising considering the weight of the unit, its design and the amount of mail it can contain.

The size of the APC also limits or prevents its use sweepside, that is, next to a stacker where human workers are sweeping mail. For this purpose a smaller cart called the 1226 is used. The 1226 is likewise a steel frame, six level cart. The top and bottom shelves are open. The four intermediate levels are each provided with a row of pull out shelves or slides. These take up considerable space, so the number of levels is limited to six total, with six shelves per row, limiting the middle levels of the cart to 24 trays of the plastic EMM type.

While a great variety of carts have been the subject of patents, none are well adapted to take the place of the 1226 in postal sweeping operations and for later transportation and unloading. See for example carts decribed in U.S. patent application No. 2009/0139913, Pippin; James M.; et al. Jun. 4, 2009.

The present invention provides a cart that can be loaded with bins of sorted mail directly onto an LLV.

### SUMMARY OF THE INVENTION

A method for transporting sorted mail includes steps sorting flat mail pieces from a sorting machine into a series of bins mounted on a rack; removing the series of bins from the rack toto shelves of an extraction cart; moving the loaded cart onto a delivery vehicle; removing the bins from the cart into positions for delivery; removing the mail from the bins and delivering the mail to the recipient.

A method for transporting sorted mail including sorting flat mail pieces from a sorting machine into a series of bins mounted on a rack; removing the series of bins from the rack toto shelves of an extraction cart; moving the loaded cart onto a delivery vehicle; removing the bins from the cart into positions for delivery; removing the mail from the bins and delivering the mail to the recipient.

The invention further contemplates an apparatus including a cart for carrying out the method of the invention.

### BRIEF DESCRIPTION OF THE DRAWING

In the accompanying drawing, like numerals denote like elements, and:

FIG. 1 is side view of a bin wall according to the invention;

FIG. 2 is a side view of an extraction cart according to the invention loaded with detachable bins according to the invention;

FIG. 3 is a side view of the extraction cart in a ready to life position;

FIG. 4 is a side view of the extraction cart in a lifted position;

FIG. 5 is an end view of the loaded extraction cart in a centered position;

FIG. 6 is a side view of an extraction cart according to the invention; and

FIG. 7 is a end view of the extraction cart shown in FIG. 6.

### DETAILED DESCRIPTION OF THE DRAWINGS

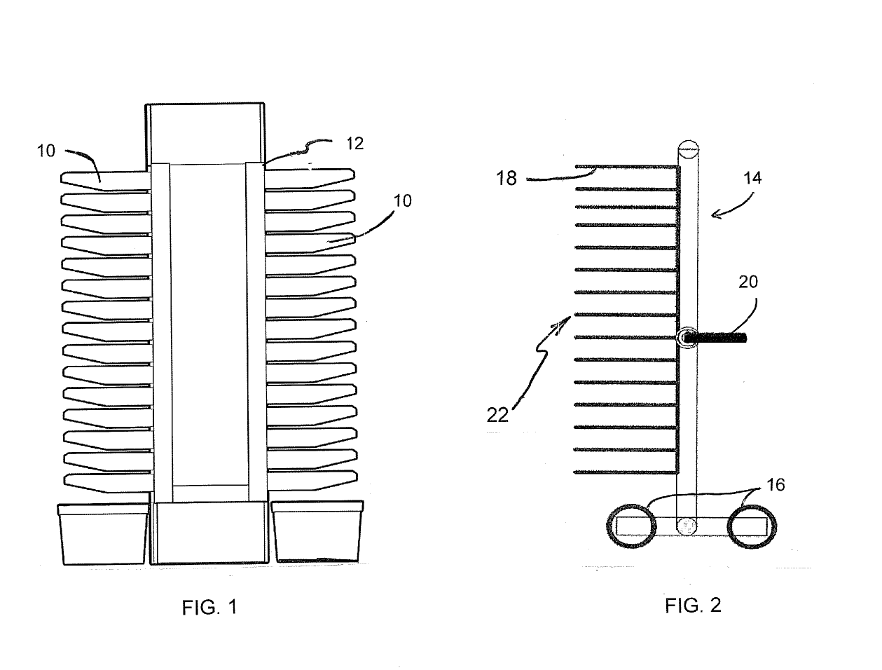

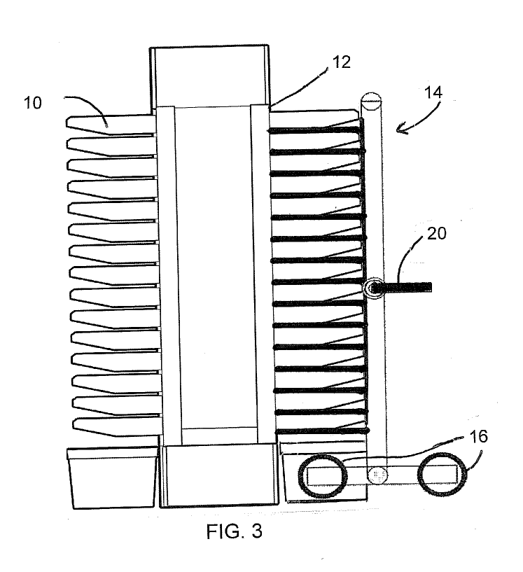

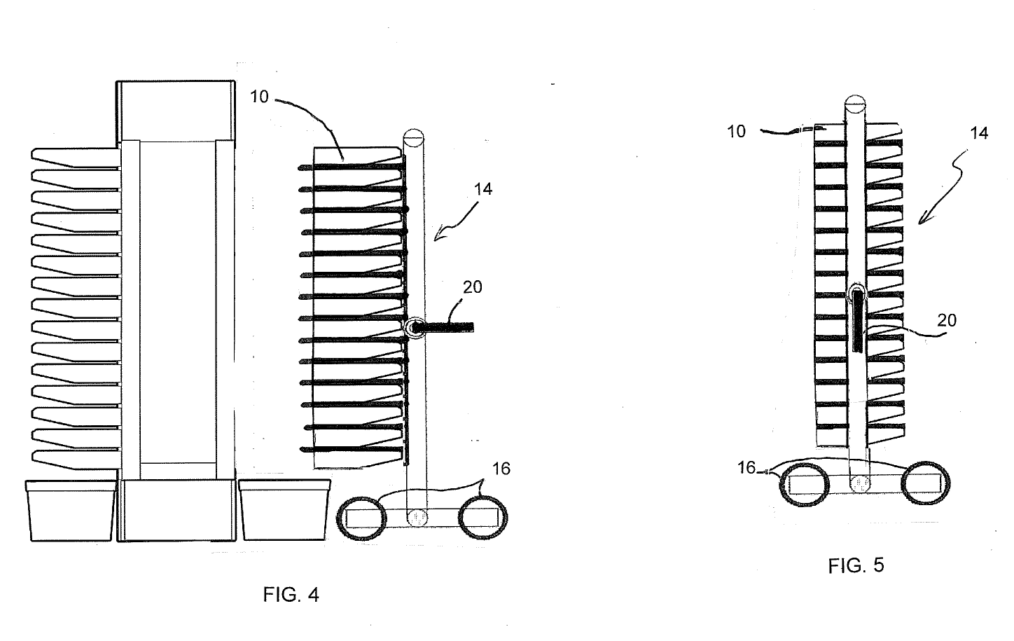

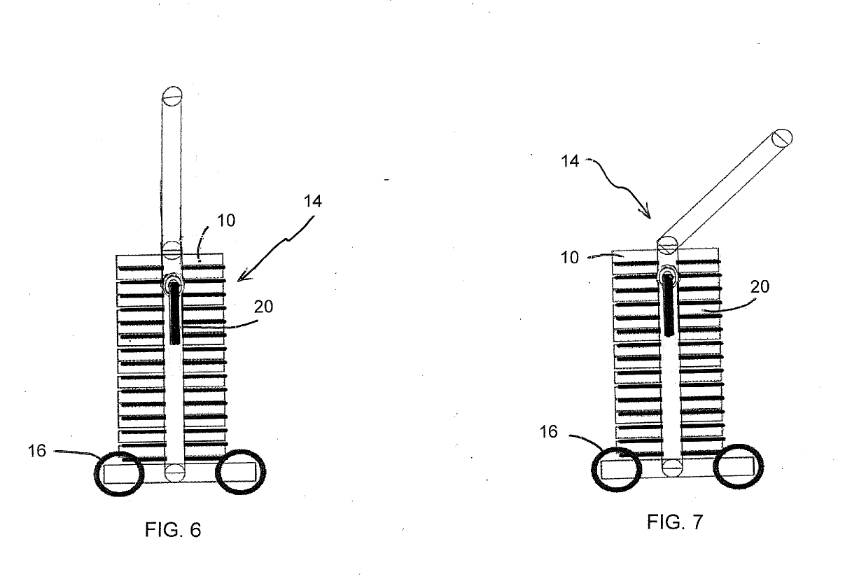

Referring to FIGS. 1-3; mail from a sorting process is sorted into a series of bins 10 are mounted in a vertical column on a bin wall 12 which is part of an otherwise conventional sorting machine such as DBCS or MLOCR An extraction cart 14 is movable by means of supporting wheels 16. Cart 14 has a series of horizontal plates 18 mounted to a lever mechanism 20. A human worker rolls cart 14 to the left in FIG. 3 so that a row of support shelves 22 is inserted under bins 10. Lever 20 is actuated to lift the bins 20 in the column, and cart 14 is rolled backwards loaded with bins 10. Cart 14 could then be loaded as is onto an LLV which for purposes of the invention refers to a LLV refers to a long life vehicle capable of transporting mail of which a motor vehicle such as a mail truck is typical. “Long in this case reerse to to the expected useful life of the vehicle, such as from 5-20 years or longer. Preferably the mail is unloaded into mail trays in the the LLV on the floor or on shelves provided for that purpose. mail trays can be stacked in a nested configuration.

1. A method for transporting sorted mail:
sorting flat mail pieces from a sorting machine into a series of bins mounted on a rack;
removing the series of bins from the rack toto shelves of an extraction cart;
moving the loaded cart onto a delivery vehicle;
removing the bins from the cart into positions for delivery; and
removing the mail from the bins and delivering the mail to the recipient.

2. An apparatus for transporting mail comprising:
a rack for storing bins containing sorted mail and an extraction cart that has a series of shelves on which the bins are received.

3. The system of claim 2 wherein the extraction cart has a series of shelves on which the bins are received.
